(19) United States
(12) Patent Application Publication
(10) Pub. No.: US 2003/0225474 A1
(43) Pub. Date: Dec. 4, 2003

(54) Specialization of active software agents in an automated manufacturing environment

(76) Inventors: Gustavo Mata, Austin, TX (US); Steven Nettles, Johnson City, TX (US); Larry D. Barto, Austin, TX (US); Yiwei Li, Austin, TX (US)

Correspondence Address: WILLIAMS, MORGAN & AMERSON, P.C., 10333 RICHMOND, SUITE 1100, HOUSTON, TX, 77042, US

(21) Appl. No.: 10/160,990

(22) Filed: May 31, 2002

(51) Int. Cl. G06F 19/00

(52) U.S. Cl. 700/121; 700/96

(57) ABSTRACT

An apparatus and method for implementing an automated processing environment employing specialized, autonomous, active software agents are disclosed. The software agents are specialized by the type of entity they represent and the function they perform in the process flow. The apparatus includes a process flow comprising a plurality of manufacturing domain entities and a plurality of such software agents for scheduling a first subset of the manufacturing domain entities for consuming the process resources provided by a second subset of the manufacturing domain entities. The method includes instantiating such software agents and then permitting them to operate as programmed.

### BACKGROUND OF THE INVENTION

1. Field of the Invention

This invention pertains to automated manufacturing environments, and, more particularly, to the specialization of active software agents in an automated manufacturing environment.

2. Description of the Related Art

Growing technological requirements and the worldwide acceptance of sophisticated electronic devices have created an unprecedented demand for large-scale, complex, integrated circuits. Competition in the semiconductor industry requires that products be designed, manufactured, and marketed in the most efficient manner possible. This requires improvements in fabrication technology to keep pace with the rapid improvements in the electronics industry. Meeting these demands spawns many technological advances in materials and processing equipment and significantly increases the number of integrated circuit designs. These improvements also require effective utilization of computing resources and other highly sophisticated equipment to aid, not only design and fabrication, but also the scheduling, control, and automation of the manufacturing process.

Turning first to fabrication, integrated circuits, or microchips, are manufactured from modem semiconductor devices containing numerous structures or features, typically the size of a few micrometers. The features are placed in localized areas of a semiconducting substrate, and are conductive, non-conductive, or semi-conductive (i.e., rendered conductive in defined areas with dopants). The fabrication process generally involves processing a number of wafers through a series of fabrication tools. Each fabrication tool performs one or more of four basic operations discussed more fully below. The four basic operations are performed in accordance with an overall process to finally produce the finished semiconductor devices.

Integrated circuits are manufactured from wafers of a semiconducting substrate material. Layers of materials are added, removed, and/or treated during fabrication to create the integrated, electrical circuits that make up the device. The fabrication essentially comprises the following four basic operations:

layering, or adding thin layers of various materials to a wafer from which a semiconductor is produced;

patterning, or removing selected portions of added layers;

doping, or placing specific amounts of dopants in selected portions of the wafer through openings in the added layers; and

heat treating, or heating and cooling the materials to produce desired effects in the processed wafer.

Although there are only four basic operations, they can be combined in hundreds of different ways, depending upon the particular fabrication process. See, e.g., Peter Van Zant, Microchip Fabrication A Practical Guide to Semiconductor Processing (3d Ed. 1997 McGraw-Hill Companies, Inc.) (ISBN 0-07-067250-4).

Controlling a semiconductor factory, however, is a challenging task. A semiconductor factory (“fab”) is a complex environment where numerous parts, typically 40 thousand wafers or more, and numerous part types, typically 100 part types or more, are simultaneously being manufactured. As each wafer moves through the fab, it may undergo more than 300 processing steps, many of which use the same machines. A large factory may contain approximately 500 computer-controlled machines to perform this wafer processing. Routing, scheduling, and tracking material through one of these factories is a difficult and complicated task, even with the assistance of a computerized factory control system.

Efficient management of a facility for manufacturing products such as semiconductor chips requires monitoring various aspects of the manufacturing process. For example, it is typically desirable to track the amount of raw materials on hand, the status of work-in-process and the status and availability of machines and tools at every step in the process. One important decision is selecting which lot should run on each machine at any given time. Also, most machines in the manufacturing process need to schedule routine preventative maintenance (“PM”) and equipment qualification (“Qual”) procedures, as well as other diagnostic and reconditioning procedures that must be performed on a regular basis, such that the performance of the procedures does not impede the manufacturing process itself.

One approach to this issue implements an automated “Manufacturing Execution System” (“MES”). An automated MES enables a user to view and manipulate, to a limited extent, the status of machines and tools, or “entities,” in a manufacturing environment. In addition, a MES enables the dispatching and tracking of lots or work-in-progress through the manufacturing process to enable resources to be managed in the most efficient manner. Specifically, in response to MES prompts, a user inputs requested information regarding work-in-process and entity status. For example, when a user performs a PM on a particular entity, the maintenance technician (“MT”) logs the performance of the PM (an “event”) into a MES screen to update the information stored in the database with respect to the status of that entity. Alternatively, if an entity is to be taken down for repair or maintenance, the MT will log this information into the MES database, which then prevents use of the entity until it is subsequently logged back up to a production ready state.

Although MES systems are sufficient for tracking lots and machines, such systems suffer several deficiencies, the most obvious of which are their passive nature, lack of advance scheduling and inability to support highly automated factory operations. Current MES systems largely depend on manufacturing personnel for monitoring factory state and initiating activities at the correct time. For example, a lot does not begin processing until a wafer fabrication technician (“WFT”) issues the appropriate MES command. And, prior to processing, a WFT must issue a MES command to retrieve the lot from the automated material handling system (“AMHS”) with sufficient advance planning that the lot is available at the machine when the machine becomes available. If the WFT does not retrieve the lot soon enough, or neglects to initiate processing at the earliest available time, the machine becomes idle and production is adversely impacted.

These types of deficiencies in the typical automated MES emphasize the importance of the WFT in the efficient operation of the manufacturing process. WFTs perform many vital functions. For instance, WFTs initiate dispatching, transport, and processing as their attention and time permits. They make scheduling decisions such as whether to run an incomplete batch, as opposed to waiting for approaching lots, or performing PM or qualification procedures instead of processing lots. WFTs perform non-value added MES transactions and utilize conventional factory control systems that are passive. In this context, the term “passive” means activities in the control system must be initiated by the WFT, as opposed to being self-starting or self-initiating.

However, the presence of WFTs also inevitably introduces some inefficiencies. There typically is a large difference between the performance of the best WFT and the performance of the worst WFT. A WFT typically simultaneously monitors the processing of multiple tools and lots, making it difficult to focus on an individual lot or tool. Furthermore, the size and complexity of the modern fabrication process flows makes it exceedingly difficult for a WFT to foresee and prevent downstream bottlenecks or shortages arising from upstream activities. Shift changes, rest breaks, and days off for the WFT also create inefficiencies or machine idle time that adversely impact the manufacturing process flow. Just as the importance of the WFT is magnified by the deficiencies of the automated MES, so are the inefficiencies of the WFT magnified by his importance.

Thus, factory control systems utilized in today's wafer fabs are passive and do not enable a high degree of automation. These systems are very dependent on wafer fab technicians and other factory staff to monitor the state of the factory, to continuously react to constant change, to make rapid logistical decisions and to initiate and coordinate factory control activity in a timely manner. These wafer fab technicians are agents, providing the active element that is lacking in factory control systems. As a result, factory effectiveness in the highly competitive semiconductor industry is quite dependent on the availability, productivity, skill level and consistency of these human agents. Wafer fab technicians must monitor and operate a number of tools located in various bays in a fab. They are forced to multiplex across tools, bays, material handling systems and a variety of factory control systems. As a fab's production ramps and more complex processes are introduced, it is difficult to meet the increased complexity and volume without increasing staff or system capabilities. Wafer fab tech visibility of upstream and downstream operations, tool state, work-in-process and resource availability is limited.

However, key logistical decisions are frequently based on this limited and dated information, which is only partially provided by factory control systems. Wafer fab techs spend a significant amount of time interacting with systems, monitoring factory events and state changes, and performing other non-value added functions, such as MES logging. Shift changes disrupt the operation of the fab as the technicians are temporarily unable to provide required monitoring and coordination. Despite the best efforts of the technicians, utilization of tools suffer, adversely impacting other key factory metrics including cycle time, inventory levels, factory output and mix. With the need for intrabay material handling to transport 12-inch wafers in new 300 mm wafer fabs, significant additional complexity is introduced. Conventional factory control systems are not capable of providing this level of detailed scheduling and execution control.

The present invention is directed to resolving, or at least reducing, one or all of the problems mentioned above.

### SUMMARY OF THE INVENTION

The invention comprises an apparatus and method for implementing an automated processing environment employing specialized, autonomous, active software agents. The software agents are specialized by the type of entity they represent and the function they perform in the process flow. The apparatus includes a process flow comprising a plurality of manufacturing domain entities and a plurality of such software agents for scheduling a first subset of the manufacturing domain entities for consuming the process resources provided by a second subset of the manufacturing domain entities. The method includes instantiating such software agents and then permitting them to operate as programmed.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a portion of one particular embodiment of a first process flow constructed and operated in accordance with the present invention;

FIG. 2 conceptually illustrates, in a partial block diagram, selected portions of the hardware and software architectures, respectively, of the computing devices in FIG. 1;

FIG. 3A conceptually illustrates in a partial block diagram the specialization of agents on a first level, i.e., as consumer agents and as provider agents in the second process flow of FIG. 1;

FIG. 3B illustrates a floating market model implementation of a contract net negotiation protocol for the process flow of FIG. 3A;

FIG. 4 conceptually illustrates in a partial block diagram the specialization of agents as to type, entity, and function in the process flow of FIG. 1;

FIG. 5A and FIG. 5B illustrate inheritance hierarchies for two classes of agents in the object oriented programming environment of the illustrated embodiment; and

FIG. 6 illustrates various classes of agents in the AEMS of the process flow in FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

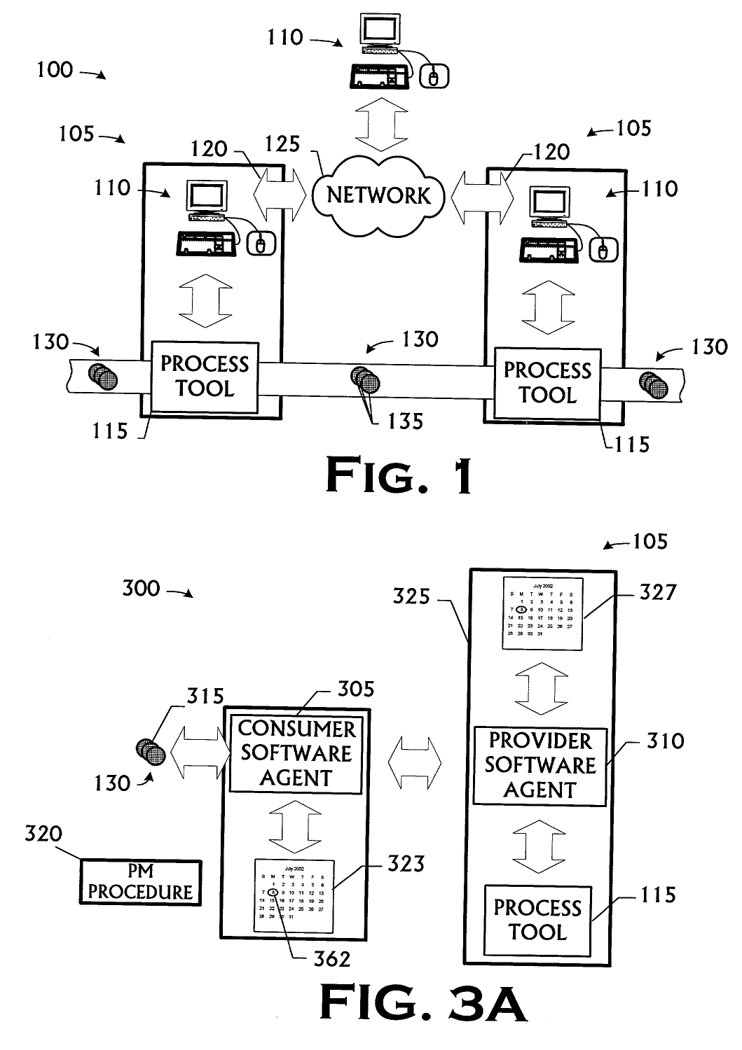

FIG. 1 conceptually illustrates a portion of one particular embodiment of a process flow 100 constructed and operated in accordance with the present invention. The process flow 100 fabricates semiconductor devices. However, the invention may be applied to other types of manufacturing processes. Thus, in the process flow 100 discussed above, the lots 130 of wafers 135 may be more generically referred to as “work pieces.” The process tools 115 and any process operations performed thereon need not necessarily be related to the manufacture of semiconductor devices in all embodiments. However, for the sake of clarity and to further an understanding of the invention, the terminology pertaining to semiconductor fabrication shall be retained in disclosing the invention in the context of the illustrated embodiments. Thus, the term “lot” is to be construed broadly, meaning any work piece that may be processed in a manufacturing process.

The illustrated portion of the process flow 100 includes two stations 105, each station 105 including a computing device 110 communicating with a process tool 115. The stations 105 communicate with one another over communications links 120. In the illustrated embodiment, the computing devices 110 and the communications links 120 comprise a portion of a larger computing system, e.g., a network 125. The process tools 115 are shown in FIG. 1 processing lots 130 of wafers 135 that will eventually become integrated circuit devices.

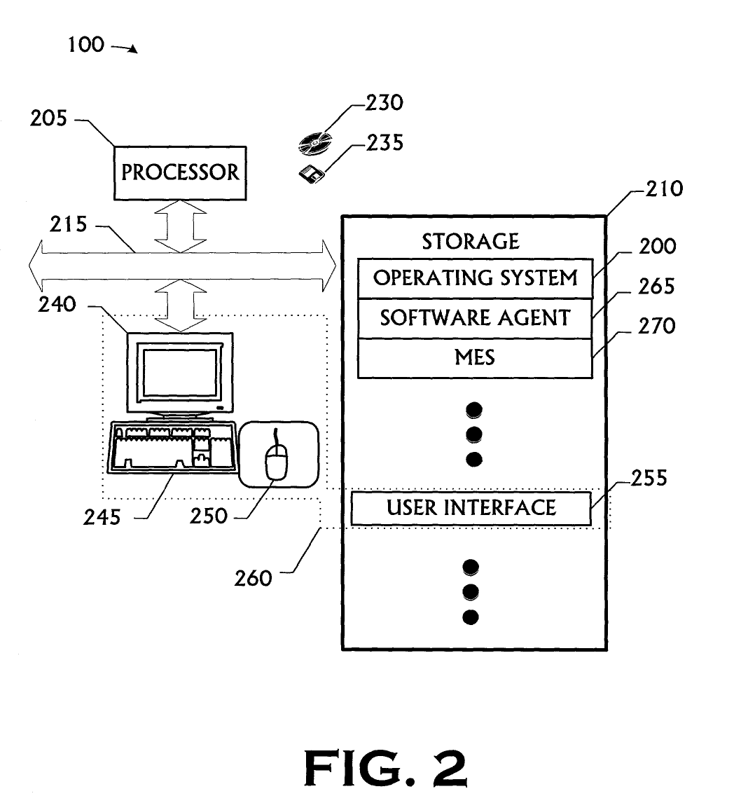

FIG. 2 depicts selected portions of the hardware and software architectures, respectively, of the computing devices 110 programmed and operated in accordance with the present invention. Some aspects of the hardware and software architecture (e.g., the individual cards, the basic input/output system (“BIOS”), input/output drivers, etc.) are not shown. These aspects are omitted for the sake of clarity, and so as not to obscure the present invention. As will be appreciated by those of ordinary skill in the art having the benefit of this disclosure, however, the software and hardware architectures of the computing devices 110 will include many such routine features.

In the illustrated embodiment, the computing device 110 is a workstation, employing a UNIX-based operating system, but the invention is not so limited. The computing device 110 may be implemented in virtually any type of electronic computing device such as a laptop computer, a desktop computer, a mini-computer, a mainframe computer, or a supercomputer. The computing device 110 may even be, in some alternative embodiments, a processor or controller embedded in the process tool 115. The invention also is not limited to UNIX-based operating systems. Alternative operating systems (e.g., Windows™-, Linux™- or disk operating system (“DOS”)-based) may also be employed. The invention is not limited by the particular implementation of the computing device 110.

The computing device 110 also includes a processor 205 communicating with some storage 210 over a bus system 215. The storage 210 will typically include at least a hard disk and some random access memory (“RAM”). The computing device 110 may also, in some embodiments, include removable storage such as the optical disk 230, or the floppy electromagnetic disk 235, or some other form such as a magnetic tape or a zip disk (not shown). The processor 205 may be any suitable processor known to the art. For instance, the processor may be a general purpose microprocessor or a digital signal processor (“DSP”). In the illustrated embodiment, the processor 205 is an Athlon™ processor commercially available from Advanced Micro Devices, Inc. (“AMD”), but the invention is not so limited. The 64-bit UltraSPARC™ or the 32-bit microSPARC™ from Sun Microsystems, any of the Itanium™, Pentium™, or Alpham™-class processors from Intel Corporation might alternatively be employed. The computing device 110 includes a monitor 240, keyboard 245, and a mouse 250, which together, along with their associated user interface software 255 (shown in FIG. 2) comprise a user interface 260. The user interface in the illustrated embodiment is a graphical user interface (“GUI”), although this is not necessary to the practice of the invention.

FIG. 2 illustrates selected portions of the software architecture of the computing devices 110. Each computing device 110 includes, in the illustrated embodiment, a software agent 265 residing thereon in the storage 210. Note that the software agents 265 may reside in the process flow 100 in places other than the computing devices 110. The situs of the software agent 265 is not material to the practice of the invention. Note also that, since the situs of the software agents 265 is not material, some computing devices 110 may have multiple software agents 265 residing thereon while other computing devices 110 may not have any. Portions of an automated MES 270, such as WORKSTREAM™, reside on at least one computing device 110.

Returning briefly to FIG. 1, as was mentioned above, the computing devices 110 may also be part of a larger computing system 125 by a connection over the communications links 120. Exemplary computing systems in such an implementation would include local area networks (“LANs”), wide area networks (“WANs”), system area networks (“SANs”), intranets, or even the Internet. The computing system 125 employs a networked client/server architecture, but alternative embodiments may employ a peer-to-peer or other type of architecture. Thus, in some alternative embodiments, the computing devices 110 may communicate directly with one another. The communications links 120 may be wireless, coaxial cable, optical fiber, or twisted wire pair links. The computing system 125, in embodiments employing one, and the communications links 120 will be implementation specific and may be implemented in any suitable manner known to the art. The computing system 125 may employ any suitable communications protocol known to the art, e.g., Transmission Control Protocol/Internet Protocol (“TCP/IP”).

Referring now to both FIG. 1 and FIG. 2, the software agents 265, collectively, are responsible for efficiently scheduling and controlling the lots 130 of wafers 135 through the fabrication process. Each process tool 115 represents some resource that may be employed for this purpose. For instance, a process tool 115 may be a fabrication tool used to fabricate some portion of the wafers 135, i.e., layer, pattern, dope, or heat treat the wafers 135. Or, a process tool 115 may be a metrology tool used to evaluate the performance of various parts of the process flow 100. Thus, the software agents 265 are capable of assessing a plurality of resources for subsequent processing of the lots 130 of wafers 135, allocating the resources represented by the process tools 115, and negotiating among themselves for the allocation of those resources for subsequent processing of the lot 130 of wafers 135.

In the illustrated embodiment, the software agents 265 are self-configuring on start-up, intelligent, state aware, and imbued with specific goals for which they autonomously initiate behaviors to achieve. The software agents 265 are also self-adjusting as their environment changes. The software agents 265 are implemented in the illustrated emobidment as objects in an object oriented programming (“OOP”) environment, but the invention may be implemented using techniques that are not object oriented. Their behavior is relatively simple and is partially configurable through scripts and properties. The behavior is designed to achieve selected goals such as achieving an assigned lot due date, achieving a predefined level of quality, maximizing machine utilization, and scheduling opportunistic preventive maintenance. In furtherance of these objectives, the software agents 265 interface with the MES 270 and are integrated with the existing factory control systems (not shown). As will be apparent to those skilled in the art having the benefit of this disclosure, the manner in which this interface and integration occurs will be implementation specific, depending upon the identity of the MES 270 and the factory control systems.

Collectively, the software agents 265 schedule ahead for each lot 130 one or more operations on a specific qualified process tool 115, including transports and required resources, as discussed more fully below. This includes making optimizing decisions such as running an incomplete batch, as opposed to waiting for an approaching lot 130, and scheduling opportunistic preventive maintenance or qualifications to meet specifications. The software agents 265 schedule and initiate activities such as lot transport and processing, perform MES transactions, monitor processing and transport, and react to unscheduled activities or deviations from scheduled activities. More particularly, the software agents 265 may, for instance:

schedule and initiate execution of material transport required for a lot 130 to meet its next processing appointment at a specified tool 115;

monitor transport activity and react to deviations;

schedule and initiate transport to a reserved machine port by a specified appointment start time;

detect machine port carrier arrival via auto-identification and equipment event;

initiate recipe download and processing to a process tool 115 via an equipment interface;

perform MES transactions;

monitor processing activity and notify WFTs of abnormalities;

detect near completion of processing via an equipment event and schedule a processing appointment for a next process in the process flow with a certified process tool 115;

initiate transport to the nearest stocker or a nearby process tool 115;

detect carrier departure and release the port;

schedule preventive maintenance procedures and notify maintenance technicians (“MTs”) at the appropriate time;

schedule qualification procedures and notify WFTs at the appropriate time; and

schedule resources (e.g., reticles, loaders, unloaders, etc.) for processing or performing a PM or a Qual.

Note that, depending on the level of implementation, a given embodiment may implement any or all of these functions, or even functions not listed above.

As will be explained further below, the software agents 265 can be specialized on several different levels to further this behavior. One level is by “type,” i.e., whether the software agents 265 represent a “consumer” or a service “provider” in the process flow 100. More particularly, whether the software agents 265 represent a consumer or a provider is determined by the type of entity it represents and the context in which the representation takes place. For example, a software agent 265 may represent a lot 130 of wafers 135 (i.e., a “lot agent”), a process tool 115 (i.e., a “machine agent”), a process resource (i.e., a “resource agent”), or a PM or a Qual (i.e., a “PM agent”). Note that some software agents 265 represent manufacturing domain entities that are consumers in some contexts and providers in others, as will be discussed more fully below. The software agents 265 are also specialized by function—i.e., by what function the software agent 265 performs in the process flow. Each specialized software agents 265 occupies a different role in the overall performance of the process flow 100 on which this embodiment is implemented.

Note that the software agents 265 need not necessarily exist in a one-to-one correspondence with manufacturing domain entities, such as lots 130, process tools 115, etc. Instead, most domain entities are each represented by a group of agents. For instance, as will be discussed more fully below, a lot 130 or a process tool 115 may have both a “scheduling” agent and a “processing” agent. This facilitates the design of specialized objects that exhibit specialized behavior to support a single aspect of domain entity functionality.

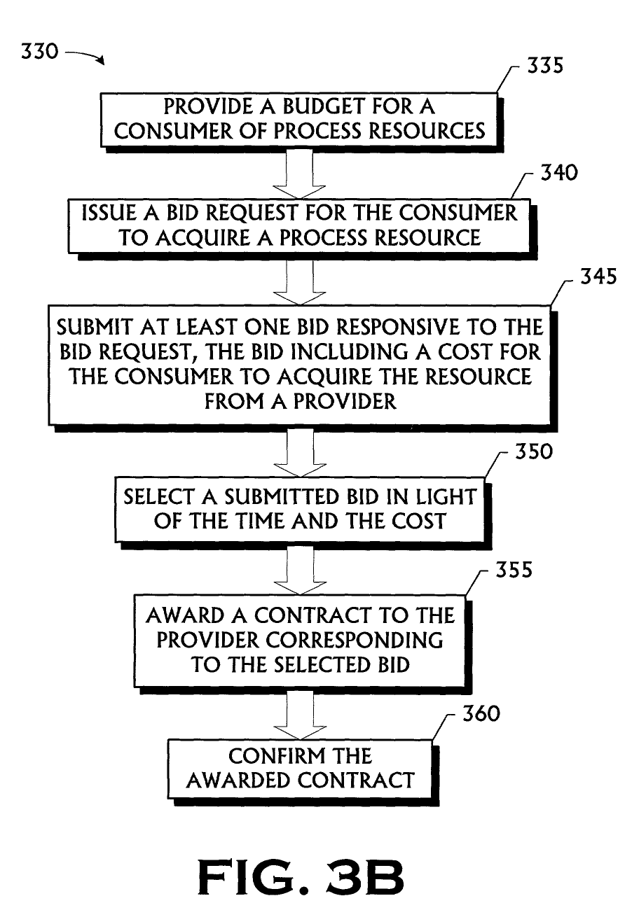

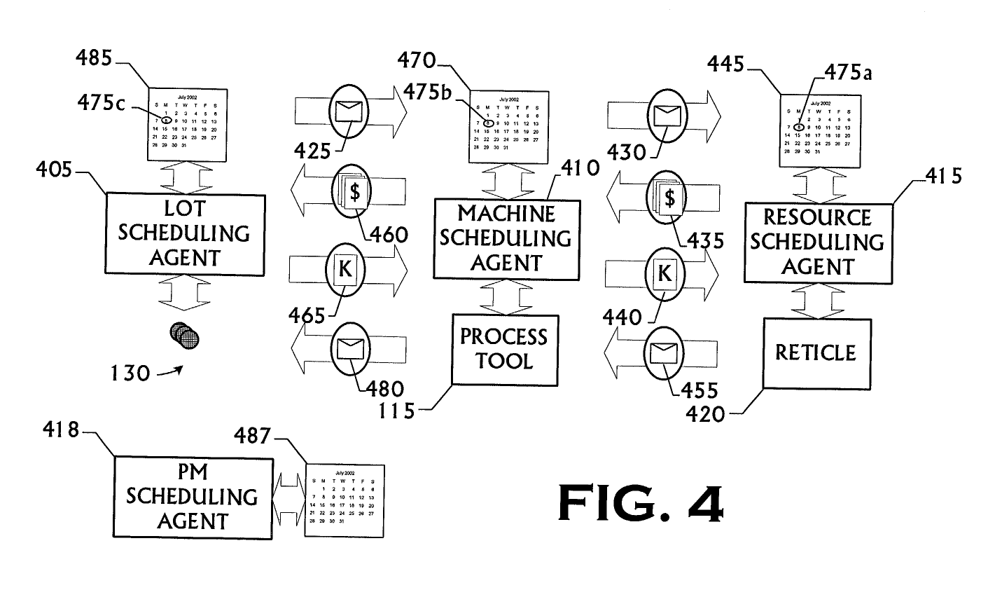

Referring now to FIG. 3A, in a general sense, the software agents 265 in an exemplary process flow 300 can typically be classed as “consumer agents” 305 and “provider agents” 310. Consumer agents 305 represent the interests of consumers 315, e.g., the lots 130 or PM procedures 320, in advancing the lots 130 through the process flow 100 in a timely and efficient manner or in performing PM or Qual procedures within the allowable window, respectively. Provider agents 310 represent the interests of providers 325, e.g., machines such as the process tool 115, in meeting the demands of consumers for processing resources in advancing the lots 130 through the process flow 100 in a timely and efficient manner. For instance, a software agent 265 representing a lot 130 of wafers 135 would be considered a “consumer” agent 305 and a software agent 265 representing a process tool 115 would be considered “provider” agent because the process tool 115 is “providing” processing services “consumed” by the lot 130. Note that, as was previously mentioned and as will be discussed still more fully below, a software agent 265 may sometimes be classed as a provider agent 310 in one context and a consumer agent 305 in another context.

As noted above, the distinction between consumer agents 305 and provider agents 310 is particularly apt in the context of scheduling. The scheduling of actions initiated by the software agents 265 in the illustrated embodiment revolve around budgets, costs, and ratios associated with the processing. More particularly, to further the implementation of a contract net negotiation protocol for allocating resources, a combination of budgets, costs, and ratios are used to implement a floating market model approach. The combination is structured to encourage “desirable” behavior, e.g., meeting due dates, effective utilization of machines, etc. More particularly, a “budget” is assigned to a consumer 315 that the consumer agent 305 uses to procure the process services of the providers 325. Similarly, the provider 325 charges consumers 315 for the processing services it represents, e.g., processing time. The amount of the budget a consumer 315 is willing to pay depends on how badly the consumer 315 needs the processing resources to stay on schedule and the amount charged by the provider 325 depends on how badly it needs to fill its schedule. In the embodiments illustrated herein, the budgets and costs are expressed in dollars, but this is not necessary to the practice of the invention. Any unit of measure may be used instead.

Turning now to FIG. 3B, there is illustrated a method 330. The method 330 may be practiced in a variety of embodiments and implementations, a particular one of which is disclosed below. The consumer software agents 305 and provider software agents 310 use a “contract net negotiation protocol” approach to schedule the consumers 315 for the providers 325. The consumer agents 305 negotiate with provider agents 310 for the consumer 315's access to the provider 325's services. This access is referred to as an “appointment.” In this particular embodiment, both the consumer agent 305 and the provider agent 310 “book” the appointment on their respective calendars.

The method 330 begins by providing a budget for the consumer 315 for a particular process resource, e.g., process time on the process tool 215, it next wants to consume, as set forth in box 335. The consumer 315 then issues through its consumer software agent 305 a bid request for the consumer 315 to acquire the process resource, as set forth in the box 340. In one implementation, the consumer software agent 305 requests bids from all eligible providers 310 on behalf of a consumer 315. When a consumer software agent 305 requests a bid, it gives the providers 310 pertinent information such as: the consumer's identification; the earliest time to begin transport; the processing operation to be scheduled; the latest completion time acceptable to the consumer 315; the location from which the consumer 315 will be transported to the provider 310; and, the consumer's “budget calculator.”

The provider 325 then, through its provider software agent 310, submits to the consumer 315 at least one bid responsive to the bid request, as set forth in the box 345. In alternative embodiments, a provider software agent 310 may not submit any bids. As mentioned above, the provider software agent maintains a calendar 327 to track appointments. When a bid request is received, the provider software agent 310 searches the calendar 327 for a time slot in which the provider 305 can potentially provide the requested service. For each potential time slot, the provider 305 submits a bid consisting of the start and end times and an optional cost.

The consumer 315, through the consumer software agent 305, then selects a submitted bid by considering the time and optional cost. The consumer 315 then awards a contract to the provider 325 for the selected bid, as set forth in the box 355, through the consumer software agent 305. However, the provider 325 typically is negotiating with several consumers 315 on an ongoing basis. It is possible that the provider 325 subsequently scheduled another consumer 315 in a manner conflicting with the submitted bid such that it can no longer accept the contract. Thus, the provider 325, through its provider software agent 310, checks the calendar 327 to see whether it can still implement the bid and accept the contract. If the bid is still feasible on the calendar 327, the provider 325 then confirms the awarded contract, as set forth in the box 360, and both the consumer and provider schedule the appointment 362 on their respective calendars 323, 327. An “appointment” is a time period certain in which the provider 325 has obligated itself to perform the activity.

Thus, decision-making in the process flow 300 is guided by economic forces of supply and demand. More particularly, consumer software agents 305 are designed to acquire services more or less aggressively depending on selected factors, such as priority or lateness. Provider software agents 310 are designed to provide such services more or less aggressively depending on a number of factors, such as the level of utilization in their calendars. Note that these decisions can be manipulated externally through configurable properties or curves that affect budgets and costs on which the decisions are based. Working like this in concert, the consumer and provider software agents 305, 310 cooperate to satisfy the consumers 305 in a timely and efficient manner.

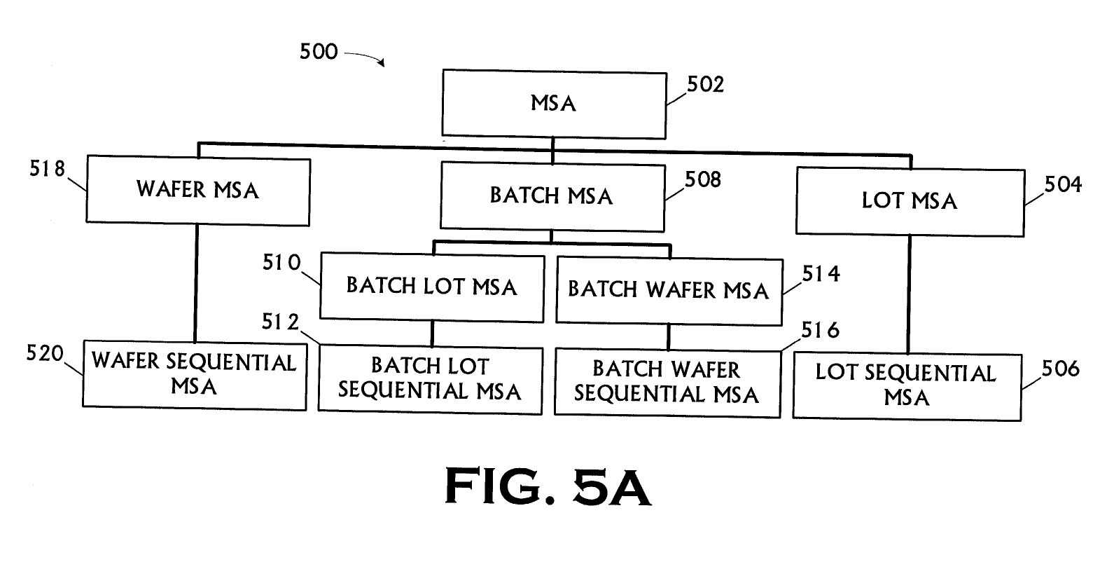

FIG. 4 depicts a portion of a semiconductor fabrication process flow 400 in which the software agents 265 of FIG. 2 embody all three levels of specialization. More particularly, the process flow 400 includes:

a PM scheduling agent (“PMSA”) 418, which is a consumer software agent representing the PM and Qual procedures for a process tool for scheduling purposes;

a lot scheduling agent (“LSA”) 405, which is a consumer software agent representing the lot 130 for scheduling purposes;

a machine scheduling agent (“MSA”) 410, which is both a consumer and a provider software agent, depending on the context in which it is operating, representing the process tool 115 for scheduling purposes; and

a resource scheduling agent (“RSA”) 415, which is a provider software agent representing the reticle 420 for scheduling purposes.

Although not shown, the lot 130, process tool 115, PM or Qual procedure (not shown) and reticle 420 all have corresponding “processing” agents to whom the scheduling agents 405, 410, 415, 418 pass control when it is time for executing the activity. Note that RSAs 415 can represent other types of process resources, e.g., dummy wafers, empty cassettes, WFTs, MTs, etc. The process flow 400 implements the floating market model approach to the contract net negotiation protocol discussed above relative to FIG. 3A and FIG. 3B. The LSA 405 tries to minimize costs while staying on schedule. The MSA 410 tries to optimize tool utilization while maximizing profits.

The LSA 405 tries to keep the lot 130 it represents on schedule. The MSA 410 tries to maximize utilization of the process tool 115 it represents. Similarly, the RSA 415 tries to maximize utilization of the resource it represents, i.e., the reticle 420. Note that the RSA 415 can represent other types of resources, e.g., machine loading resource, dummy wafers, cassettes, wafer fab technicians, maintenance technicians, etc., in other implementations. The PMSA 418 attempts to opportunistically schedule PMs and Quals on, inter alia, the process tool 115. The various agents 405, 410, 415, and 418 do this in the context of negotiating appointments for the consumption of processing resources by adjusting the prices they offer or budgets to pay for services in accordance with the schedules they need to meet or want to keep.

More particularly, a lot 130 typically negotiates with a number of pieces of equipment, e.g., process tools 115. The LSA 405 tries to find a time slot offered by a process tool that will allow the lot 130 to meet its due date and feed the next bottleneck machine station at the appropriate time. At the same time, the MSA 410 tries to acquire lots 130 for processing in a way that optimizes the utilization of the process tool 115. Overall, the goals of the MSA 410 are to maximize the overall utilization of its respective process tool 115, respect the relative priority of the lots 130, reduce setup or recipe changes, and optimize its batch size. This collaboration of agent interaction results in the scheduling of a lot 130 on a particular process tool 115 within a specified time window.

In general terms, the LSA 405 begins the negotiation by publishing a “request bid” message 425 to all of the MSAs 410 representing process tools 115 capable of performing a desired manufacturing operation. At this point, a MSA 410 is acting as a provider because the process tool 115 is providing processing services, i.e., processing time. The MSA 410 for each capable process tool 115, upon receipt of the request bid message 425, identifies a potential bid, recognizes that it will need a qualified reticle 420 to perform the job, and publishes its own request bid message 430 to the RSAs 415 of all capable resources, i.e., qualified reticles 420. The MSA 410 has now shifted from a provider at this point to a consumer since the process tool 115 is now consuming process services, i.e., time with the reticle 420. Each RSA 415 representing a qualified reticle 420 submits one or more bids 435, one of which the MSA 410 selects for inclusion in its bid 460. The MSA 410, having now identified the necessary resources, returns to its role as a provider of processing services. If another potential bid is identified by the MSA 410, it once again requests bids from the appropriate RSAs 415.

Each MSA 410 representing a capable process tool 115 submits one or more bids 460 to the LSA 405 that published the request bid message 425. The LSA 405 selects one bid 460 from among all the submitted bids 460 of all the MSAs 410. The LSA 405 then awards the contract 465 to the MSA 410 submitting the selected bid 460. The MSA 410 checks its machine calendar 470, determines that the bid is still available and, if so, awards the contract 440 to the reticle 420 that submitted the selected bid 435. The RSA 415 checks its resource calendar 445, sees that the bid is still available, and schedules the appointment 475a on its own resource calendar 445. The RSA 415 then confirms the contract with a “confirm bid” message 455, and the MSA 410 schedules an appointment 475b on its machine calendar 470, with a reference to the RSA 415 that provided the “resource” bid 435. The MSA 410 then sends a “confirmed bid” message 480 to the LSA 405. The LSA 405 then schedules the corresponding appointment 475c on its own lot calendar 485. When the time arrives for the appointments 475a, 475b, 475c to execute, the scheduling agents 405, 410, and 415 pass control to their respective processing agents (not shown).

Thus, although agents of the same type are usually programmed with similar behavior, differentiation occurs to create specialized agents. Comparing the behavior of the MSA 410 to the LSA 405 and the RSA 415 in the above discussion readily reveals such differentiation. However, more subtle differentiations exist, as well, in the illustrated embodiment. For example, there are many types of process tools 115, and each type of process tool 115 might possess different characteristics for which a respective software agent 265 may need specialization. Exemplary characteristics that may lend themselves to specialization in machine agents in the illustrated embodiment include:

whether the process tool 115 processes by wafer, by lot 130, by batches of lots 130, or by batches of wafers;

whether the process tool 115 processes wafers, lots 130, or batches serially (i.e., completes processing of a first unit before beginning processing of a second) or sequentially (“cascading,” i.e., capable of beginning processing of a second unit before completing processing of a first);

the number of ports for the process tool 115;

whether the ports for the process tool 115 are input, output, or input/output;

whether the chambers for the process tool 115 are used in series or in parallel;

whether the process tool 115 can chain PMs;

the number of chambers in the process tool 115;

whether the process tool 115 includes internal storage;

whether the process tool 115 can queue the processing of a lot 130 or batch while processing another lot 130 or batch;

whether the process tool 115 requires loading and/or unloading;

whether the process tool 115 requires resources and, if so, whether those resources are dedicated resources or shared resources.

Note, however, that the factors along which a machine agent, or any software agent 265, are specialized will be highly implementation specific.

Consider, for instance, an implementation wherein machine agents are specialized by whether they process by wafer, by lot, by batch, etc. In one particular embodiment, the following machine agents are employed:

a baseline processing agent;

a wafer-based, processing agent;

a wafer-based, sequential processing agent;

a wafer-based, batch sequential processing agent;

a wafer-based, batch processing agent;

a lot-based processing agent;

a lot-based, sequential processing agent;

a lot-based, batch processing agent;

a lot-based batch, sequential processing agent;

a baseline scheduling agent;

a wafer-based, scheduling agent;

a wafer-based, sequential scheduling agent;

a wafer-based, batch sequential scheduling agent;

a wafer-based, batch scheduling agent;

a lot-based scheduling agent;

a lot-based, sequential scheduling agent;

a lot-based, batch scheduling agent; and

a lot-based, batch sequential scheduling agent.

This particular embodiment implements the agents using object oriented programming techniques and the baseline agents provide the class definition and the other agents are subclasses of that class. Calendars, e.g., the calendar 327 in FIG. 3A, may also be specialized as are the machines with which they are associated. Thus, in the embodiment mentioned immediately above, the following specialized calendars are used:

a wafer-based, sequential calendar;

a wafer-based, serial calendar;

a wafer-based, serial batch calendar;

a wafer-based, batch sequential calendar

a lot-based, serial calendar;

a lot-based, sequential calendar;

a lot-based, serial batch calendar; and

a lot-based, batch sequential calendar.

Note, however, that this is not necessary to the practice of the invention.

Other agent specializations might also be employed. PM agents may be specialized by whether the maintenance procedures they perform are based on time, wafers processed, lots processed, batches processed, processing time, an occurrence of an event, etc. In one particular embodiment, the following specialized PM agents are employed:

wafer-based PM scheduling agents;

time-based PM scheduling agents;

processing unit-based (e.g., number of lots 130 processed, number of batches processed) PM scheduling agents;

processing time-based (e.g., cumulative processing time) PM scheduling agents;

event-based PM scheduling agents (e.g., an end of processing event);

wafer-based PM processing agents;

time-based PM processing agents;

processing unit-based (e.g., number of lots 130 processed, number of batches processed) PM processing agents;

processing time-based (e.g., cumulative processing time) PM processing agents; and

event-based PM processing agents (e.g., an end of processing event).

Each PM Scheduling Agent contains unique behavior due to the different types of PMs. For example, a time-based PM Scheduling Agent schedules PMs based on time (e.g., 30 day PM). The time-based PM Scheduling Agent determines the time the PM is due by adding 30 days to the last occurrence of the PM. On the other side, an event-based PM Scheduling Agent behaves differently. The event-based PM Scheduling Agent is scheduling PMs based on events occurring on the tool (e.g., End Etch PM). When the Event-based PM Scheduling Agent detects an end etch event has occurred, it will schedule a PM on that specific process tool 115.

LSAs can be specialized for reasons such as:

priority;

product; and

product family.

Thus, a LSA may have a different behavior in selecting a bid based on the lot's priority, product, or product family. For example, a higher priority lot will select a bid based on the time it can be processed, while a lower priority lot would select a bid based on cost. A lot may also behave differently based on the lot's product family. As an example, consider a flash processor lot versus a microprocessor lot. A flash processor might have the behavior of getting through the process flow as quickly as possible. In this case, the lot will select bids based on time. In the other hand, a microprocessor might have the opposite behavior and would select bids based on cost.

Resource agents may likewise be specialized as scheduling or processing agents and by whether they represent dedicated resources (e.g., a loading resource) or a shared resource (e.g., a WFT, reticle, dummy wafer, or empty carrier), as well as by the specific type of resource they represent. Still other specializations may be employed in alternative embodiments.

The OOP environment in which the illustrated embodiment is illustrated is well suited for specialization of this type. As will be appreciated by those skilled in the art, an OOP environment comprises numerous software-implemented objects, each of which belongs to an object type, or object class. In the illustrated embodiment, processing agents and scheduling agents belong to two different object classes. Objects within a class can be differentiated into an “inheritance hierarchy,” in which lower levels inherit characteristics of higher levels while including attributes or characteristics that distinguish them from the higher levels.

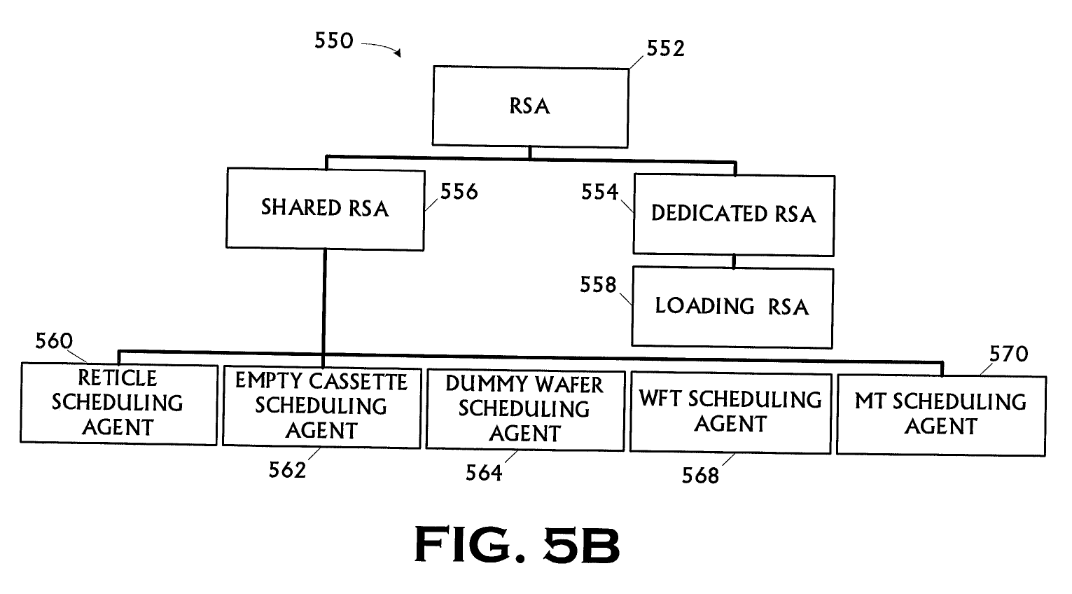

Consider the inheritance hierarchy 500, shown in FIG. 5A, for the MSA object class. The MSA 502 is the baseline class for MSAs. The MSA 502 contains the behavior shared by all of the MSAs. For example, the MSA 502 is responsible for creating and removing appointment start time and end time alarms. The agent also constructs some common helper classes, which include, for instance, Appointment Change Notifier, Appointment Change Listener, Machine Stats, Machine Listener, Bid Request Subscriber, Early Starter, Penalty Refund Calculator, Bump Evaluator, Shift Lot Right Rescheduler, and Machine Bid Requestor. All of these concepts are discussed more fully below. The MSA 502 is also responsible for requesting a tool status. The LSAs also call on the MSA 502 to generate or confirm bids. All of the behaviors in the MSA 502 are inherited by the MSAs. The MSAs include a Lot MSA 504, a Lot Sequential MSA 506, a Batch MSA 508, a Batch Lot MSA 510, a Batch Lot Sequential MSA 512, a Batch Wafer MSA 514, a Batch Wafer Sequential MSA 516, a Wafer Machine Scheduling Agent 518, and a Wafer Sequential MSA 520.

In addition to inheriting the baseline behavior, each specialized MSA contains unique behavior and overrides some inherited behaviors. Most of the unique behavior, in the illustrated embodiment, is based on how the process tool 115 associated with the MSA processes lots 130. Some of the behaviors include processing the tool status, processing equipment events, reacting to appointment state changes, reacting to factory state changes, determining the consumption time for a lot or batch, and creation of specialized helper classes (discussed further below). In order to illustrate the different behaviors between the scheduling agents, we will compare and contrast the behavior of a Wafer MSA 518 versus a Batch Lot MSA 510.

A Wafer MSA 518 (representing, e.g., a plasma strip tool) processes a wafer at a time for a given lot. On the other hand, a Batch Lot MSA 510 (representing, e.g., a furnace) processes a batch of several lots at a time. During initialization, both agents 510, 518 will request a tool status. The tool status received by the agents 510, 518 is unique. The Wafer MSA 518 will receive a tool status that contains information based on wafers while the Batch Lot MSA 510 will receive a tool status based on lot batches. Each agent 510, 518 will uniquely process the tool status in order to discover the state of the machine. Another difference between the agents 510, 518 is how they process equipment events. The events depend on how the machine processes lots. In the case of a wafer machine, some equipment events are wafer based. With a batch lot machine, some of the equipment events are time based. For example, the near complete event is triggered when the process tool 115 is almost done processing the lot 130 or batch. On a wafer-based machine, the event is triggered when a given number of wafers are remaining. On a batch lot machine, the event is triggered when time remaining reaches a particular threshold.

Determining the consumption time of a new appointment is also different between the Wafer MSA 518 and the Batch Lot MSA 510. The number of wafers 135 a lot 130 contains and the process operation determine the consumption time on a wafer-based machine. On the other hand, a Batch Lot MSA 510 uses a batch consumption time for the process and process operation. When the scheduling agent receives the near complete event, the agent determines if it should expand or shrink the appointment. In the case of a Wafer MSA 518, the agent 518 determines the number of remaining wafers to be processed. It will then determine the remaining consumption time based on the remaining wafer count. It will shrink or expand the appointment based on the remaining consumption time. The Batch Lot MSA 510 receives the remaining consumption time within the near complete event. It will shrink or expand the appointment based on the remaining consumption time.

Alternatively, consider the inheritance hierarchy 550 of FIG. 5B. The RSA object class 552, is the baseline class for all RSAs. The baseline RSA 552 contains the behavior shared by all of the RSAs. For example, the baseline RSA 552 is responsible for creating and removing appointment start time and end time alarms. The baseline RSA 552 is further classified into two sub classes: dedicated RSAs 554 and shared RSAs 556. A typical example of a dedicated resource is the loading resource responsible for loading and unloading lots 130 on a batch processing tool 115. Such a dedicated resource is represented by a dedicated RSA 554, e.g., the loading RSA 558. Typical examples for a shared resource are reticles, empty cassettes, dummy wafers, WFTs and MTs. Such shared resources are represented by shared RSAs 556, e.g., the reticle scheduling agent 560, the empty cassette scheduling agent 562, dummy wafer scheduling agent 564, WFT scheduling agent 568, MT scheduling agent 570.

One of the specialized behaviors of a loading RSA 558 is the loading order optimization. Every time a loading RSA 558 receives an appointment change event related to update of the earliest arrival time of a lot 130, it will determine an optimized loading order of all the lots 130 in a batch, such that the loading of all the batch participants can be completed in the shortest time. Another specialized behavior of a loading RSA 558 is the scheduling of unloading appointments when a batch job has late arrival lots 130. In a desired setting, all the loading for the second batch job will be scheduled to complete before the discharge start time of the first batch job. So when the discharging of the first batch job completed, we can start the charging of the second batch job, and the unloading of the lots 130 in the first batch will be scheduled after the charge end time of the second batch. However, if one lot 130 in the second batch can not arrive at the processing tool 115 early enough to be loaded before the discharge start time of the first batch, the loading appointment for this lot 130 has to be scheduled after the completion of the discharging of the first batch. Under this circumstance, the RSA will have different specialized behaviors depending upon the nature of the process operation processed on the processing tool 115. In one case, the process operation performed on one type of batch processing tools 115 is very close to the end of the process route, and the RSA would always schedule unloading appointments for the first batch immediately after the end of the discharging, and then the late arrival's loading appointment is scheduled after the unloading of the first batch. In some other cases, the process operation is not very close to the end of the process route, and there is no such urgency to rush the unloading appointments, so the late arrival lots 130 will be scheduled for loading following the discharging of the first batch job and unloading of the first batch will be scheduled after the completion of the charging of the second batch job.

For a dedicated RSA 554, because of the nature of a dedicated resource, no move appointment is required to transport the resource between appointments. However, for a shared RSA 556, because the resource has to be shared between a group of processing tools 115 or lots 130, a move appointment has to be scheduled between two appointments if these two appointments are scheduled for two different locations. So a shared RSA 556 will have its own specialized behavior when creating and booking a resource processing appointment: a move appointment will be created and booked if a transport of the resource is necessary. A shared RSA 556 also has its own specialized behaviors regarding bid generation and bid confirmation. It allows a higher priority processing tool 115 or lot 130 to bump appointments for less important processing tools 115 or lots 130.

Other specialized RSAs also exhibit other specialized behaviors. For the WFT or MT scheduling agents 568, 570, each has specialized behavior to consider the constraints related to the person's qualifications (skills), break time requirements and shift limitations. One difference between the WFT an MT is that typically an MT is needed for the full duration of a repair or PM, while a WFT may be needed only part of the time. For instance, a WFT may be needed at a process tool 115 during loading and unloading but can perform other tasks while the tool 115 is processing. An empty cassette scheduling agent 562 has specialized behavior because it is dynamically created and then ceases to exist after being used. An empty cassette ceases to be a shared resource after it is used to store wafers, while a cassette carrying a production lot can become an empty cassette if the wafers are removed from the cassette. Dummy wafer scheduling agents 564 have specialized behavior because these wafers require periodic refurbishing. Dummy wafers are used to fill empty slots in some batch machines that require a minimum load size for correct processing. Dummy wafers must be taken out of service after a specific amount of usage and cannot be used again until they are refurbished.

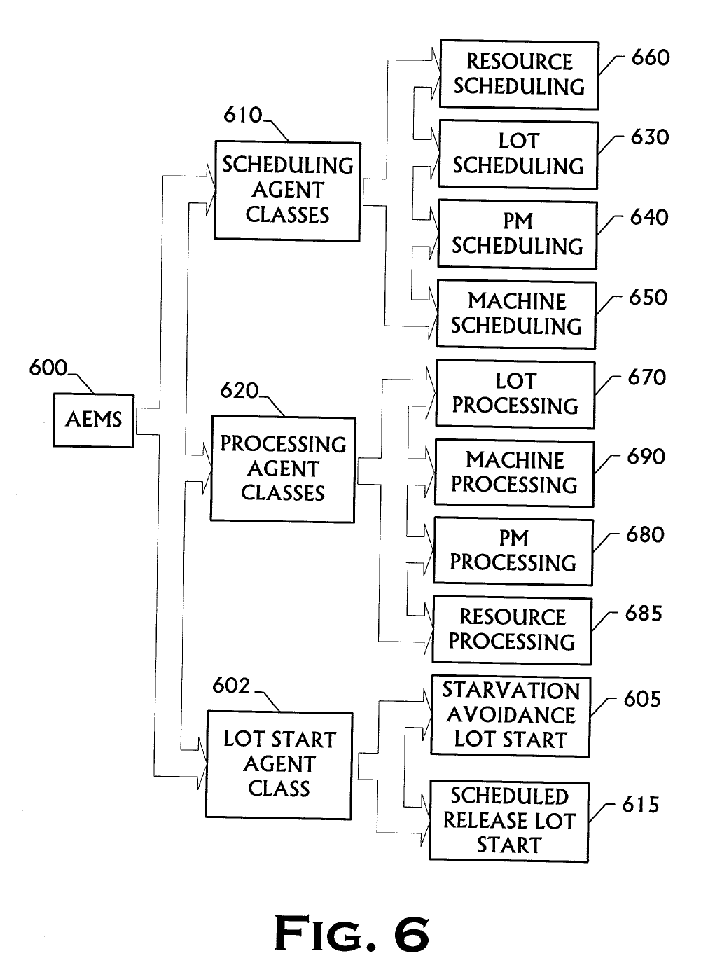

Thus, the AEMS 600 of the illustrated embodiment comprises a number of software components including, in part, the software objects illustrated in FIG. 6. These include the following classes:

a scheduling agent class 610, further including:

LSAs 630 that schedule processing and associated move appointments on behalf of a specified lot 130;

MSAs 650 that schedule appointments with other scheduling agents on behalf of a specified machine;

PM scheduling agents (“PSAs”) 640 that schedule specified PM and Qual appointments on behalf of a specified machine; and

RSAs 660 that schedule the use of secondary resources (e.g., reticles, WFTs, MTs);

a processing agent class 620, further including:

lot processing agents (“LPAs”) 670 that execute lot processing and move appointments;

machine processing agents (“MPAs”) 690 that execute setup, lot processing or batch processing, and PM and Qual appointments;

PM processing agents (“PPAs”) 680 that execute PM and Qual appointments; and

resource processing agents (“RPAs”) 685 that execute resource-specific appointments (e.g., loads and unloads for machine loading resources, resource movement, resource usage); and

a lot start agent class 602, further including:

starvation avoid ance lot start agent (“SALSA”) 605 that releases lots just in time to prevent bottleneck starvation; and

a scheduled release lot start agent (“SRLSA”) 615 that releases lots according to a predetermined schedule.

Alternative embodiments may employ still other classes.

As mentioned, the SALSA agent 605 determines when new lots 130 are released into the process flow of the fab. More particularly, the SALSA agent 605 monitors work in process (“WIP”) in the process flow and identifies one or more workstations that create bottlenecks in the process flow. The SALSA agent 605 calculates a WIP value representing the amount of work approaching each bottleneck workstation and determines whether the WIP value is projected to fall below a control limit during an evaluation period. If the WIP value is projected to fall below the control limit during the evaluation period, a selected amount of additional work is released into the manufacturing line. In some implementations, the SALSA agent 605 even determines one or more product types for the selected amount of additional work.

The AEMS 600 also comprises a number of software components (not shown) in “helper classes” that are used by the software agents 265 to accomplish their functions.

These other components can be generally grouped as follows:

calculators, for calculating various quantities (e.g., lot budget calculator, latest completion time calculator, bid cost calculator);

schedulers, for scheduling various events (e.g., move schedulers);

listeners, for detecting and reporting the occurrence of selected events or changes in state (e.g., lot listeners, bid listeners)

an alarm clock that provides time (real or simulated) to components of the AEMS 500 components and the ability to set an alarm for a specified time or period and listener to be invoked; and

adapters, that provide interfaces to other aspects of the manufacturing facility, e.g., the MES, the El, the AMHS, such as:

MES adapters that interface with the MES to perform MES transactions, e.g., track-in/out lot or machine, put lot on hold, etc.;

EI adapters that send commands to equipment interfaces (e.g., download recipes, request tool status, etc.) and that receive event information from equipment interfaces via equipment event dispatchers;

AMHS adapters that send move commands to the AMHS and receive move status updates from the AMHS; and

notification adapters that send various forms of notification (e.g., screen, pager, e-mail, etc.) to fab personnel (e.g., WFTs).

Table 1 lists these helper class components by agent for one particular embodiment of the invention.

TABLE 1
Helper Class Objects Called by Software Agents

| Software | Helper | Functionality of Helper |
|---|---|---|
| Agent | Class Object | Class Object |
| Lot | AMHS Listener | Listens for and reports AMHS move events |
| Scheduling | Bid Requestor | Generates and publishes bid requests |
| Agent | Bid Selector | Selects bids on cost and time |
| | Composite Ratio | Calculates a composite ratio, which is a |
| | Calculator | combination of a hunger ratio and a critical ratio |
| | Hunger Ratio Calculator | Calculates the agent's hunger ratio, which is a |
| | | measure of whether a particular lot needs to be |
| | | accelerated to feed a bottleneck downstream in the |
| | | process flow |
| | Critical Ratio Calculator | Calculates the agent's critical ratio, which is a |
| | | measure of whether a particular lot is on schedule |
| | Lot Budget Calculator | Determines and maintains the agent's budget for |
| | | processing |
| | LDT Calculator | Calculates the agent's latest delivery time or |
| | | completion date |
| | Move Appointment | Schedules move appointments |
| | Scheduler | |
| | Lot Scheduling Calendar | Stores and manipulates appointments |
| | Lot Appointment | Schedules processing appointments |
| | Scheduler | |
| | Lot Listener | Listens for and reacts to state changes that effect |
| | | appointment durations |
| Machine | Machine Listener | Listens for and reacts to state changes that impact |
| Scheduling | | appointments |
| Agent | Chamber Scheduling | Reacts to chambers events that will impact the |
| | Agent | throughput of the machine |
| | Chamber Listener | Listens for chamber events |
| | Machine Capability | Responsible for maintaining the process |
| | | capabilities of the machine |
| | Early Starter | Finds an appointment to start when the machine is |
| | | idle |
| | Lot Shift Right | Responds to lot requests to shift appointment to a |
| | Rescheduler | later start time |
| | Total Transport Calculator | Called by the bid generator, it calculates the total |
| | | transport time for a given lot |
| | Bid Generator | Generates bids from a bid request; calls the open |
| | | slot generator, bumping slot generator, and batch |
| | | bid generator |
| | Bumping Bid Generator | Called by the bid generator, it generates bids that |
| | | bump other appointments on the machine |
| | | scheduling calendar |
| | Open Slot Bid Generator | Called by the bid generator, it generates bids in |
| | | open slots on the machine scheduling calendar |
| | Bid Cost Calculator | Calculates a cost for a specified bid |
| | Bid Confirmer | Rejects a bid or books an accepted appointment on |
| | | a calendar |
| | Batch Bid Generator | Called by the bid generator, it generates bids for a |
| | | lot to join a batch or start a new batch |
| | Machine Scheduling | Stores and manipulates appointments |
| | Calendar | |
| PM | Machine Listener | Listens for and reacts to state changes for |
| Scheduling | | machines that impact appointments |
| Agent | Chamber Listener | Listens for chamber events |
| | PM Scheduling Calendar | Stores and manipulates appointments |
| | PM Bid Selector | Selects a PM bid |
| | PM Window Calculator | Calculates the window in which a PM may be |
| | | performed |
| | PM Budget Calculator | Calculates the budget for a PM |
| | Bid Requestor | Generates a bid request for a specified service and |
| | | sends the request to the appropriate MSA |
| Lot | MES Adapter | Initiates MES transactions |
| Processing | Notification | Notifies appropriate fab personnel |
| Agent | AMHS Facade | Initiates lot transport activities |
| Machine | Lot Listener | Listens for events pertaining to lots that affect the |
| Processing | | machine processing |
| Agent | MES Adapter | Initiates MES transactions |
| | Notification | Notifies appropriate fab personnel |
| | EI Adapter | Sends commands to the equipment interface (“EI”) |
| PM | MES Adapter | Initiates MES transactions |
| Processing | Notification | Notifies appropriate fab personnel |
| Agent | EI Adapter | Sends commands to the equipment interface (“EI”) |
| Resource | MES Adapter | Initiates MES transactions |
| Processing | Notification | Notifies appropriate fab personnel |
| Agent | EI Adapter | Sends commands to the equipment interface (“EI”) |
| Resource | Loading Order Calculator | Calculates a proper loading order and feasible |
| Scheduling | | loading start time for all the participants of a batch |
| Agent | | appointment. |
| | Bumping Bid Request | Responds to a bumping bid request from a MSA, it |
| | Processor | generates a bumping bid feasible on the resource |
| | | scheduling calendar. |
| | Open Slot Bid Request | Responds to an open slot bid request from a MSA, |
| | Processor | it generates an open slot bid feasible on the |
| | | resource scheduling calendar. |
| | Join Batch Bid Request | Responds to a join batch bid request from a MSA, |
| | Processor | it generates a join batch bid feasible on the |
| | | resource scheduling calendar. |
| | Join Batch Bumping Bid | Responds to a join batch bumping bid request from |
| | Request Processor | a MSA, it generates a join batch bumping bid |
| | | feasible on the resource scheduling calendar. |
| | Shift Left Actions | Generates a collection of appointment shift and |
| | Converter | jump over actions for a given shift left action |
| | | collection coming from the corresponding machine |
| | | scheduling calendar |
| | Shift Right Actions | Generates a collection of appointment shift and |
| | Converter | jump over actions for a given shift right action |
| | | collection coming from the corresponding machine |
| | | scheduling calendar |
| | Bumping Feasibility | Evaluates the feasibility of a bumping bid, if it is |
| | Processor | feasible, it will generate a collection of actions to |
| | | accomplish the bumping bid. |
| | Open Slot Feasibility | Evaluates the feasibility of an open slot bid, if it is |
| | Processor | feasible, it will generate a collection of actions to |
| | | accomplish the open slot bid. |
| | Join Batch Feasibility | Evaluates the feasibility of a join batch bid, if it is |
| | Processor | feasible, it will generate a collection of actions to |
| | | accomplish the join batch bid. |
| | Join Batch Bumping | Evaluates the feasibility of a join batch bumping |
| | Feasibility Processor | bid, if it is feasible, it will generate a collection of |
| | | actions to accomplish the join batch bumping bid. |
| | Machine Listener | Listens for and reacts to state changes of a |
| | | machine that impact appointments. |
| | Resource Scheduling | Stores and manipulates appointments. |
| | Calendar | |

In this particular embodiment, the software agents are implemented using object-oriented programming techniques. In the terminology of object-oriented computing, a software “agent” is an autonomous, active object. Given its set of operations, a software agent can take independent action in response to local conditions, thereby generating adaptable system behavior. The present invention presents an agent-enhanced system that defines, configures, and deploys autonomous and mobile “software agents” that mimic and improve the functioning of “real world” agents in a semiconductor manufacturing plant such as factory workers, material, equipment, resources, etc. One skilled in the art will recognize that an agent or other software object can include one or more software objects. As used herein, the term “object” will be understood to be a software object that may, in turn, be composed of other software objects. Conversely, one skilled in the art will also recognize that the functionality of one object may combined with other functionalities. It is to be understood that functionalities described as being associated with separate objects may be combined into the functionality associated with a single object.

Some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A process flow in an automated manufacturing environment, comprising:
a plurality of manufacturing domain entities; and
a plurality of autonomous, active software agents associated with the manufacturing domain entities, the software agents being specialized by type of entity represented and function to schedule a first subset of the manufacturing domain entities for consuming the process resources provided by a second subset of the manufacturing domain entities.

2. The process flow of claim 1, wherein the manufacturing domain entities include at least one of:
a process tool;
a preventive maintenance/qualification procedure for the process tool;
a process resource employed by the process tool; and
a lot for processing on the process tool.

3. The process flow of claim 1, wherein the software agents include at least one of a scheduling agent and a processing agent.

4. The process flow of claim 3, wherein the scheduling agent comprises one of a machine scheduling agent, a lot scheduling agent, a PM scheduling agent, and a resource scheduling agent.

5. The process flow of claim 4, wherein the resource scheduling agent comprises one of a dedicated resource scheduling agent and a shared resource scheduling agent.

6. The process flow of claim 3, wherein the processing agent comprises one of a machine processing agent, a lot processing agent, a PM processing agent, and a resource processing agent.

7. The process flow of claim 6, wherein the resource processing agent comprises one of a dedicated resource processing agent and a shared resource processing agent.

8. The process flow of claim 1, wherein the software agents include at least one of a machine agent, a lot agent, a PM agent, and a resource agent

9. The process flow of claim 8, wherein the machine agent comprises one of a machine scheduling agent and a machine processing agent.

10. The process flow of claim 8, wherein the lot agent comprises one of a lot scheduling agent and a lot processing agent.

11. The process flow of claim 8, wherein the PM agent comprises one of a PM scheduling agent and a PM processing agent.

12. The process flow of claim 8, wherein the resource agent comprises one of a resource scheduling agent and a resource processing agent.

13. The process flow of claim 1, wherein the software agents are further specialized by the characteristics of the particular entity they represent.

14. The process flow of claim 13, wherein the software agents include at least one of a specialized machine agent, a specialized lot agent, a specialized resource agent, and a specialized PM agent.

15. The process flow of claim 14, wherein the specialized machine agent for a process tool is specialized according to at least one of:
whether the process tool processes by wafer, by lot, by batches of lots, or by batches of wafers;
whether the process tool processes wafers, lots or batches serially or sequentially;
the number of ports for the process tool;
whether the ports for the process tool are input, output, or input/output;
whether the chambers for the process tool are used in series or in parallel;
whether the process tool can chain PMs;
the number of chambers in the process tool;
whether the process tool includes internal storage;
whether the process tool can queue the processing of a lot or a batch while processing another lot or batch;
whether the process tool requires loading and/or unloading; and
whether the process tool requires resources and, if so, whether those resources are dedicated resources or shared resources.

16. The process flow of claim 14, wherein the specialized lot agent is specialized by at least one of a priority, product or product family of the lot it represents.

17. The process flow of claim 14, wherein the specialized resource agent is specialized by the type of resource.

18. The process flow of claim 17, where the type of the resource is selected from the group consisting of a shared resource and a dedicated resource.

19. The process flow of claim 14, wherein the specialized preventive maintenance agent is specialized according to at least one of a wafer-based PM, a time-based PM, a processing unit-based PM, a processing time-based PM, and an event-based PM.

20. The process flow of claim 1, wherein the software agents includes lot start agent.

21. The process flow of claim 20, wherein the lot start agent comprises one of a starvation avoidance lot start agent or a scheduled release lot start agent.

22. A process flow in an automated manufacturing environment, comprising:
a plurality of manufacturing domain entities; and
means for representing the manufacturing domain entities function to schedule a first subset of the manufacturing domain entities for consuming the process resources provided by a second subset of the manufacturing domain entities, the representing means being specialized by type of entity represented.

23. The process flow of claim 22, wherein the manufacturing domain entities include at least one of:
a process tool;
a preventive maintenance/qualification procedure for the process tool;
a process resource employed by the process tool; and
a lot for processing on the process tool.

24. The process flow of claim 22, wherein the representing means include at least one of a means for scheduling on behalf the manufacturing entities and a means for representing processing on behalf the manufacturing entities.

25. The process flow of claim 22, wherein the representing means include at least one of means for representing a process tool, means for representing a lot, means for representing a PM, and means for representing a resource.

26. The process flow of claim 22, wherein the representing means are further specialized by the characteristics of the particular entity they represent.

27. An automated manufacturing environment, comprising:
a plurality of manufacturing domain entities, including:
a plurality of process tools;
a plurality of preventive maintenance/qualification procedures for the process tools;
a plurality of process resources employed by the process tools; and
a plurality of lots for processing on the process tools; and
a computing system, including:
a plurality of machine agents for scheduling and executing activities on the process tools;
a plurality lot agents for scheduling the lots for processing on the process tools and executing actions to facilitate the processing of the lots on the process tools;
a plurality of resource agents for scheduling the utilization of the process resources by the process tools and executing actions to facilitate the use of the process resources by the process tools; and
a plurality of preventive maintenance agents for scheduling and executing the preventive maintenance/qualification procedures on the process tools.

28. The automated manufacturing environment of claim 27, wherein the machine agents include at least one of a machine scheduling agent for scheduling activities on the process tools and a machine processing agent for executing scheduled activities on the process tools.

29. The process flow of claim 27, wherein at least one of the machine agents is specialized according to at least one of:
whether the process tool processes by wafer, by lot, by batches of lots, or by batches of wafers;
whether the process tool processes wafers, lots or batches serially or sequentially;
the number of ports for the process tool;
whether the ports for the process tool are input, output, or input/output;
whether the chambers for the process tool are used in series or in parallel;
whether the process tool can chain PMs;
the number of chambers in the process tool;
whether the process tool includes internal storage;
whether the process tool can queue the processing of a lot or a batch while processing another lot or batch;
whether the process tool requires loading and/or unloading; and
is whether the process tool requires resources and, if so, whether those resources are dedicated resources or shared resources.

30. The automated manufacturing environment of claim 27, wherein the lot agents include at least one of a lot scheduling agent and a lot processing agent.

31. The automated manufacturing environment of claim 27, wherein at least one of the lot scheduling agent and the lot processing agent is specialized by at least one of the priority, product or product family of the lot it represents.

32. The automated manufacturing environment of claim 27, wherein the resource agents include at least one of a resource scheduling agent and a resource processing agent.

33. The automated manufacturing environment of claim 27, wherein the preventive maintenance agents include at least one of a PM scheduling agent and a PM processing agent.

34. The automated manufacturing environment of claim 27, further comprising a plurality of lot start agents.

35. An automated manufacturing environment, comprising:
a plurality of manufacturing domain entities, including:
a plurality of process tools;
a plurality of preventive maintenance/qualification procedures for the process tools;
a plurality of process resources employed by the process tools; and
a plurality of lots for processing on the process tools; and
a computing system, including:
a plurality of scheduling agents for scheduling activities for the preventive maintenance/qualification procedures, process resources, and lots on the process tools; and
a plurality of processing agents for executing the scheduled activities.

36. The automated manufacturing environment of claim 35, wherein at least one of the scheduling agents and processing agents is specialized according to the nature of the entity it represents.

37. The automated manufacturing environment of claim 35, wherein the scheduling agents include at least one of:
a machine scheduling agent for scheduling activities on the process tools;
a lot scheduling agent for scheduling the lots for processing on the process tools;
a preventive maintenance scheduling agent for scheduling the preventive maintenance/qualification procedures on the process tools; and
a resource scheduling agent for scheduling the utilization of the process resources by the process tools.

38. The automated manufacturing environment of claim 35, wherein the processing agents include at least one of:
a machine processing agent for executing scheduled activities on the process tools;
a lot processing agent for executing actions to facilitate the processing of the lots on the process tools;
a resource processing agent for executing actions to facilitate the use of the process resources by the process tools; and
a plurality of preventive maintenance processing agents for executing scheduled preventive maintenance/qualification procedures on the process tools.

39. The automated manufacturing environment of claim 35, wherein the software agents includes lot start agent.

40. A method for automated processing, comprising:
instantiating a plurality of autonomous, active software agents associated with a plurality of manufacturing domain entities, the software agents being specialized by type of entity represented and function to schedule a first subset of the manufacturing domain entities for consuming the process resources provided by a second subset of the manufacturing domain entities;
scheduling appointments for the first subset to consume the process resources; and
executing the scheduled appointments.

41. The method for automated processing of claim 40, wherein instantiating the plurality of autonomous, active software agents associated with the plurality of manufacturing domain entities includes instantiating a plurality of autonomous, active software agents associated with a plurality of manufacturing domain entities including at least one of:
a process tool;
a preventive maintenance/qualification procedure for the process tool;
a process resource employed by the process tool; and
a lot for processing on the process tool.

42. The method for automated processing of claim 40, wherein instantiating the plurality of autonomous, active software agents includes instantiating at least one of a scheduling agent and a processing agent.

43. The method for automated processing of claim 40, wherein instantiating the plurality of autonomous, active software agents includes instantiating at least one of a machine agent, a lot agent, a PM agent, and a resource agent.

44. The method for automated processing of claim 40, wherein instantiating the plurality of autonomous, active software agents includes instantiating a plurality of software agents further specialized by the characteristics of the particular entity they represent.

45. The method for automated processing of claim 40, further comprising instantiating a lot start agent.

46. An automated manufacturing environment, comprising:
means for instantiating a plurality of autonomous, active software agents associated with a plurality of manufacturing domain entities, the software agents being specialized by type of entity represented and function to schedule a first subset of the manufacturing domain entities for consuming the process resources provided by a second subset of the manufacturing domain entities;
means for scheduling appointments for the first subset to consume the process resources; and
means for executing the scheduled appointments.

47. The automated manufacturing environment of claim 46, wherein the means for instantiating the plurality of autonomous, active software agents associated with the plurality of manufacturing domain entities includes means for instantiating a plurality of autonomous, active software agents associated with a plurality of manufacturing domain entities including at least one of:
a process tool;
a preventive maintenance/qualification procedure for the process tool;
a process resource employed by the process tool; and
a lot for processing on the process tool.

48. The automated manufacturing environment of claim 46, wherein the means for instantiating the plurality of autonomous, active software agents includes means for instantiating at least one of a scheduling agent and a processing agent.

49. The automated manufacturing environment of claim 46, wherein the means for instantiating the plurality of autonomous, active software agents includes means for instantiating at least one of a machine agent, a lot agent, a PM agent, and a resource agent

50. The automated manufacturing environment of claim 46, wherein the means for instantiating the plurality of autonomous, active software agents includes means for instantiating a plurality of software agents further specialized by the characteristics of the particular entity they represent.

51. The automated manufacturing environment of claim 46, further comprising means for instantiating a lot start agent.

52. A computer-readable, program storage medium encoded with instruction that, when executed by a computer, perform a method for automated processing, the method comprising:
instantiating a plurality of autonomous, active software agents associated with a plurality of manufacturing domain entities, the software agents being specialized by type of entity represented and function to schedule a first subset of the manufacturing domain entities for consuming the process resources provided by a second subset of the manufacturing domain entities;
scheduling appointments for the first subset to consume the process resources; and
executing the scheduled appointments.

53. The program storage medium of claim 52, wherein instantiating the plurality of autonomous, active software agents associated with the plurality of manufacturing domain entities in the encoded method includes instantiating a plurality of autonomous, active software agents associated with a plurality of manufacturing domain entities including at least one of:
a process tool;
a preventive maintenance/qualification procedure for the process tool;
a process resource employed by the process tool; and
a lot for processing on the process tool.

54. The program storage medium of claim 52, wherein instantiating the plurality of autonomous, active software agents in the encoded method includes instantiating at least one of a scheduling agent and a processing agent.

55. The program storage medium of claim 52, wherein instantiating the plurality of autonomous, active software agents in the encoded method includes instantiating at least one of a machine agent, a lot agent, a PM agent, and a resource agent

56. The program storage medium of claim 52, wherein instantiating the plurality of autonomous, active software agents in the encoded method includes instantiating a plurality of software agents further specialized by the characteristics of the particular entity they represent.

57. The program storage medium of claim 52, wherein the encoded method further comprises instantiating a lot start agent.

58. A computing system programmed to perform a method for automated processing, the method comprising:
instantiating a plurality of autonomous, active software agents associated with a plurality of manufacturing domain entities, the software agents being specialized by type of entity represented and function to schedule a first subset of the manufacturing domain entities for consuming the process resources provided by a second subset of the manufacturing domain entities;
scheduling appointments for the first subset to consume the process resources; and
executing the scheduled appointments.

59. The computing system of claim 58, wherein instantiating the plurality of autonomous, active software agents associated with the plurality of manufacturing domain entities in the programmed method includes instantiating a plurality of autonomous, active software agents associated with a plurality of manufacturing domain entities including at least one of:
a process tool;
a preventive maintenance/qualification procedure for the process tool;
a process resource employed by the process tool; and
a lot for processing on the process tool.

60. The computing system of claim 58, wherein instantiating the plurality of autonomous, active software agents in the programmed method includes instantiating at least one of a scheduling agent and a processing agent.

61. The computing system of claim 58, wherein instantiating the plurality of autonomous, active software agents in the programmed method includes instantiating at least one of a machine agent, a lot agent, a PM agent, and a resource agent

62. The computing system of claim 58, wherein instantiating the plurality of autonomous, active software agents in the programmed method includes instantiating a plurality of software agents further specialized by the characteristics of the particular entity they represent.

63. The computing system of claim 58, wherein the programmed method further comprises instantiating a lot start agent.

64. A method for automated processing, comprising:
instantiating a plurality of autonomous, active software agents, including:
a plurality of machine agents for scheduling and processing operations on a plurality of process tools;
a plurality of lot agents for scheduling and processing a plurality of lots on the process tools;
a plurality of resource agents for scheduling and processing the utilization of a plurality of process resources by the process tools;
a plurality of preventive maintenance agents for scheduling and processing a plurality of preventive maintenance/qualification procedures on the process tools;
scheduling appointments for the lots for processing on the process tools and for the process tools to utilize the process resources; and
executing the scheduled appointments.

65. The method for automated processing of claim 64, wherein instantiating the software agents includes instantiating a plurality of software agents further specialized by the characteristics of the particular entity they represent.

66. The method for automated processing of claim 64, wherein scheduling appointments includes implementing a contract net negotiation protocol.

67. The method for automated processing of claim 64, further comprising instantiating a starvation avoidance lot start agent.
